(19) United States
(12) Patent Application Publication
(10) Pub. No.: US 2025/0267602 A1
(43) Pub. Date: Aug. 21, 2025

(54) SYNCHRONIZED DATA TRANSMISSION

(71) Applicant: Samsung Electronics Co., Ltd., Suwon-si (KR)

(72) Inventor: Anil Agiwal, McKinney, TX (US)

(21) Appl. No.: 19/046,495

(22) Filed: Feb. 5, 2025

Related U.S. Application Data
(60) Provisional application No. 63/556,201, filed on Feb. 21, 2024.
(60) Provisional application No. 63/695,609, filed on Sep. 17, 2024.

(51) Int. Cl. H04W 56/00; H04W 8/22; H04W 76/20

(52) U.S. Cl. CPC H04W 56/0015; H04W 8/22; H04W 76/20

(57) ABSTRACT

A UE includes a processor, and a transceiver operatively coupled to the processor. The transceiver is configured to transmit, to a base station (BS), an indication that the UE supports synchronized data transmission, and receive, from the BS, a configuration indicating a linking between at least two data flows of a plurality of data flows for synchronized data transmission, wherein each data flow of the plurality of data flows is one of a data radio bearer (DRB) or a logical channel (LCH). The transceiver is also configured to receive, from the BS, a configuration of a synchronization threshold for the linked at least two data flows.

### CROSS-REFERENCE TO RELATED APPLICATION(S) AND CLAIM OF PRIORITY

This application claims priority under 35 U.S.C. § 119 (e) to U.S. Provisional Patent Application No. 63/556,201 filed on Feb. 21, 2024, and U.S. Provisional Patent Application No. 63/695,609 filed on Sep. 17, 2024. The above-identified provisional patent applications are hereby incorporated by reference in their entirety.

### TECHNICAL FIELD

This disclosure relates generally to wireless networks. More specifically, this disclosure relates to synchronized data transmission.

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage is of paramount importance.

To meet the demand for wireless data traffic having increased since deployment of 4G communication systems, and to enable various vertical applications, 5G communication systems have been developed and are currently being deployed. The enablers for the 5G/NR mobile communications include massive antenna technologies, from legacy cellular frequency bands up to high frequencies, to provide beamforming gain and support increased capacity, new waveform (e.g., a new radio access technology [RAT]) to flexibly accommodate various services/applications with different requirements, new multiple access schemes to support massive connections, and so on.

### SUMMARY

This disclosure provides apparatuses and methods for synchronous data transmission.

In one embodiment, a user equipment (UE) is provided. The UE includes a processor, and a transceiver operatively coupled to the processor. The transceiver is configured to transmit, to a base station (BS), an indication that the UE supports synchronized data transmission, and receive, from the BS, a configuration indicating a linking between at least two data flows of a plurality of data flows for synchronized data transmission, wherein each data flow of the plurality of data flows is one of a data radio bearer (DRB) or a logical channel (LCH). The transceiver is also configured to receive, from the BS, a configuration of a synchronization threshold for the linked at least two data flows.

In another embodiment, a BS is provided. The BS includes a processor, and a transceiver operatively coupled to the processor. The transceiver is configured to receive, from a UE, an indication that the UE supports synchronized data transmission, and transmit, to the UE, a configuration indicating a linking between at least two data flows of a plurality of data flows for synchronized data transmission, wherein each data flow of the plurality of data flows is one of a DRB or an LCH. The transceiver is also configured to transmit, to the UE, a configuration of a synchronization threshold for the linked at least two data flows.

In yet another embodiment, a method of operating a UE is provided. The method includes transmitting, BS, an indication that the UE supports synchronized data transmission, and receiving, from the BS, a configuration indicating a linking between at least two data flows of a plurality of data flows for synchronized data transmission, wherein each data flow of the plurality of data flows is one of a DRB or an LCH. The method also includes receiving, from the BS, a configuration of a synchronization threshold for the linked at least two data flows.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present disclosure;

FIGS. 2A and 2B illustrate example wireless transmit and receive paths according to embodiments of the present disclosure;

FIG. 3A illustrates an example UE according to embodiments of the present disclosure;

FIG. 3B illustrates an example gNB according to embodiments of the present disclosure;

FIG. 4 illustrates an example method for synchronized data transmission according to embodiments of the present disclosure;

FIGS. 5A-5B illustrate an example method for UE capability indication according to embodiments of the present disclosure;

FIG. 6 illustrates another example method for synchronized data transmission according to embodiments of the present disclosure; and

FIG. 7 illustrates another example method for synchronized data transmission according to embodiments of the present disclosure.

### DETAILED DESCRIPTION

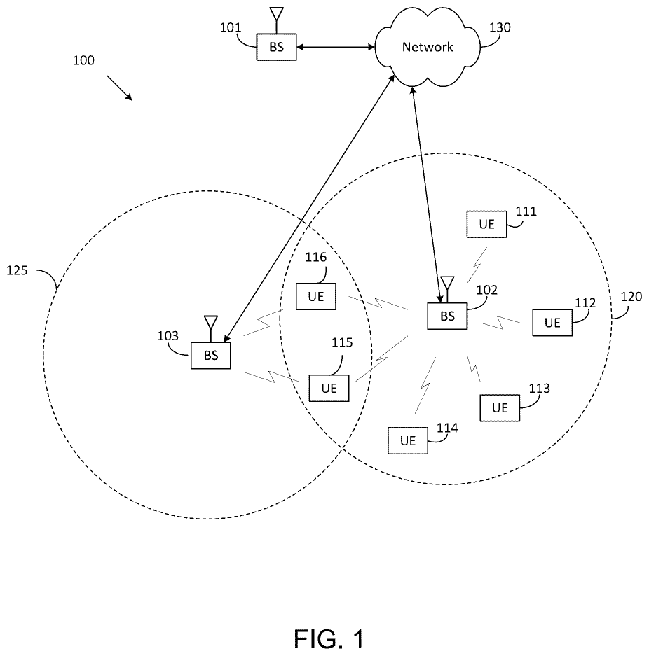

FIGS. 1 through 7, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands (e.g., 28 GHz or 60 GHz bands), so as to accomplish higher data rates or in lower frequency bands, such as 6 GHZ, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band.

For example, aspects of the present disclosure may also be applied to deployment of 5G communication systems, 6G or even later releases which may use terahertz (THz) bands.

FIGS. 1-3B below describe various embodiments implemented in wireless communications systems and with the use of orthogonal frequency division multiplexing (OFDM) or orthogonal frequency division multiple access (OFDMA) communication techniques. The descriptions of FIGS. 1-3B are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for synchronous data transmission. In certain embodiments, one or more of the gNBs 101-103 includes circuitry, programing, or a combination thereof, to support synchronous data transmission in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

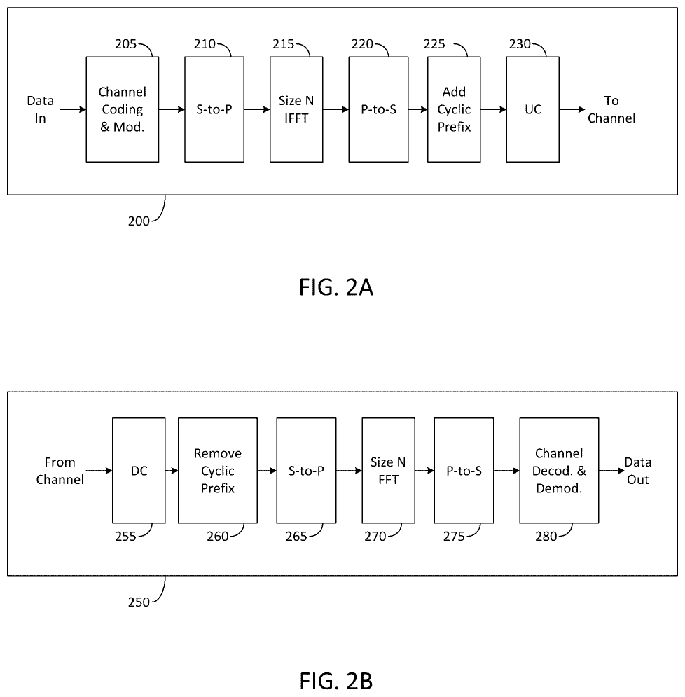

FIGS. 2A and 2B illustrate example wireless transmit and receive paths according to embodiments of the present disclosure. In the following description, a transmit path 200 may be described as being implemented in a gNB (such as gNB 102), while a receive path 250 may be described as being implemented in a UE (such as UE 116). However, it will be understood that the receive path 250 can be implemented in a gNB and that the transmit path 200 can be implemented in a UE. In some embodiments, the transmit path 200 and/or the receive path 250 is configured to implement and/or support synchronous data transmission as described in embodiments of the present disclosure.

The transmit path 200 includes a channel coding and modulation block 205, a serial-to-parallel (S-to-P) block 210, a size N Inverse Fast Fourier Transform (IFFT) block 215, a parallel-to-serial (P-to-S) block 220, an add cyclic prefix block 225, and an up-converter (UC) 230. The receive path 250 includes a down-converter (DC) 255, a remove cyclic prefix block 260, a serial-to-parallel (S-to-P) block 265, a size N Fast Fourier Transform (FFT) block 270, a parallel-to-serial (P-to-S) block 275, and a channel decoding and demodulation block 280.

In the transmit path 200, the channel coding and modulation block 205 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 210 converts (such as de-multiplexes) the serial modulated symbols to parallel data in order to generate N parallel symbol streams, where N is the IFFT/FFT size used in the gNB 102 and the UE 116. The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 in order to generate a serial time-domain signal. The add cyclic prefix block 225 inserts a cyclic prefix to the time-domain signal. The up-converter 230 modulates (such as up-converts) the output of the add cyclic prefix block 225 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116. The down-converter 255 down-converts the received signal to a baseband frequency, and the remove cyclic prefix block 260 removes the cyclic prefix to generate a serial time-domain baseband signal. The serial-to-parallel block 265 converts the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream.

Each of the gNBs 101-103 may implement a transmit path 200 that is analogous to transmitting in the downlink to UEs 111-116 and may implement a receive path 250 that is analogous to receiving in the uplink from UEs 111-116. Similarly, each of UEs 111-116 may implement a transmit path 200 for transmitting in the uplink to gNBs 101-103 and may implement a receive path 250 for receiving in the downlink from gNBs 101-103.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 2A and 2B illustrate examples of wireless transmit and receive paths, various changes may be made to FIGS. 2A and 2B. For example, various components in FIGS. 2A and 2B can be combined, further subdivided, or omitted and additional components can be added according to particular needs. Also, FIGS. 2A and 2B are meant to illustrate examples of the types of transmit and receive paths that can be used in a wireless network. Any other suitable architectures can be used to support wireless communications in a wireless network.

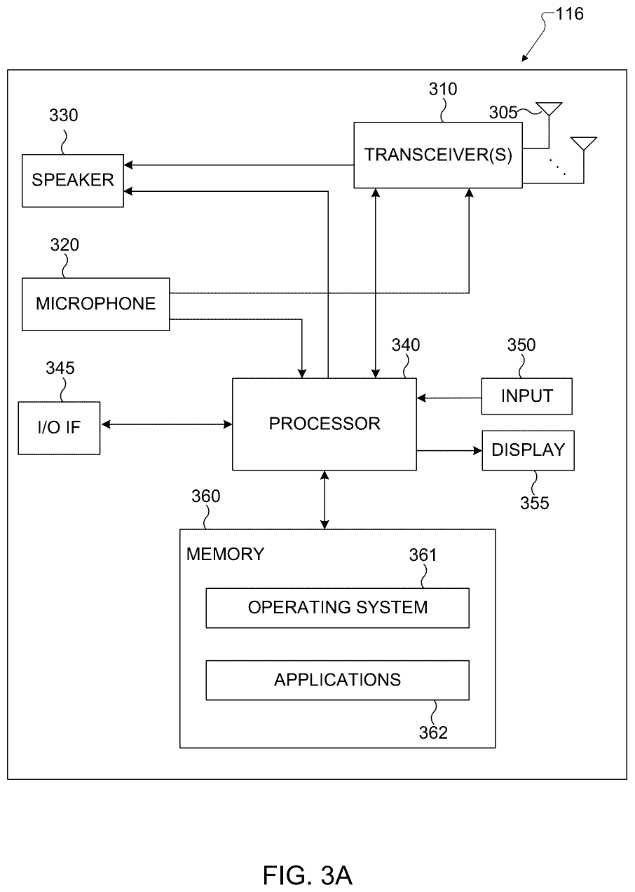

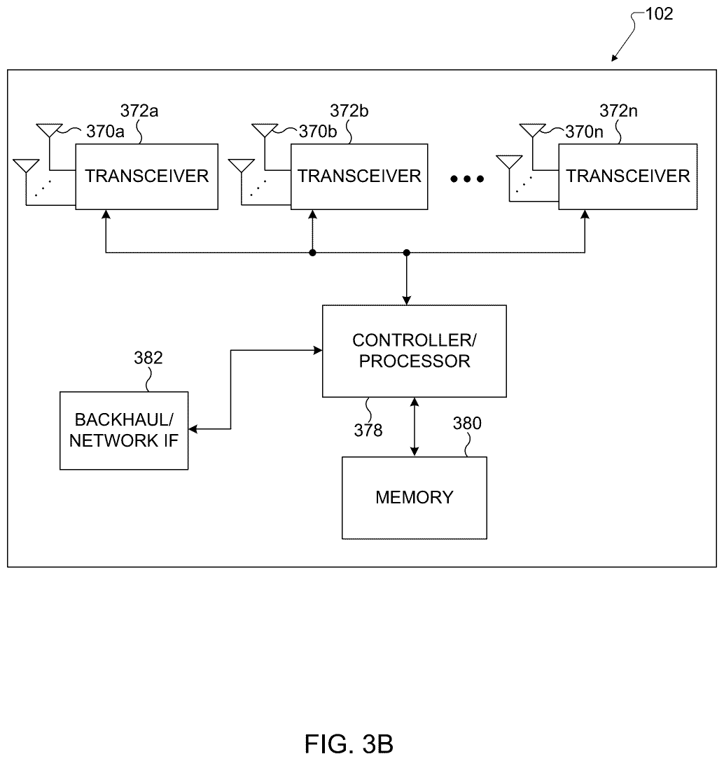

FIG. 3A illustrates an example UE 116 according to embodiments of the present disclosure. The embodiment of the UE 116 illustrated in FIG. 3A is for illustration only, and the UEs 111-115 of FIG. 1 could have the same or similar configuration. However, UEs come in a wide variety of configurations, and FIG. 3A does not limit the scope of this disclosure to any particular implementation of a UE.

As shown in FIG. 3A, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes for synchronous data transmission as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3A illustrates one example of UE 116, various changes may be made to FIG. 3A. For example, various components in FIG. 3A could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3A illustrates the UE 116 configured as a mobile telephone or smartphone, UEs could be configured to operate as other types of mobile or stationary devices.

FIG. 3B illustrates an example gNB 102 according to embodiments of the present disclosure. The embodiment of the gNB 102 illustrated in FIG. 3B is for illustration only, and the gNBs 101 and 103 of FIG. 1 could have the same or similar configuration. However, gNBs come in a wide variety of configurations, and FIG. 3B does not limit the scope of this disclosure to any particular implementation of a gNB.

As shown in FIG. 3B, the gNB 102 includes multiple antennas 370a-370n, multiple transceivers 372a-372n, a controller/processor 378, a memory 380, and a backhaul or network interface 382.

The transceivers 372a-372n receive, from the antennas 370a-370n, incoming RF signals, such as signals transmitted by UEs in the network 100. The transceivers 372a-372n down-convert the incoming RF signals to generate IF or baseband signals. The IF or baseband signals are processed by receive (RX) processing circuitry in the transceivers 372a-372n and/or controller/processor 378, which generates processed baseband signals by filtering, decoding, and/or digitizing the baseband or IF signals. The controller/processor 378 may further process the baseband signals.

Transmit (TX) processing circuitry in the transceivers 372a-372n and/or controller/processor 378 receives analog or digital data (such as voice data, web data, e-mail, or interactive video game data) from the controller/processor 378. The TX processing circuitry encodes, multiplexes, and/or digitizes the outgoing baseband data to generate processed baseband or IF signals. The transceivers 372a-372n up-converts the baseband or IF signals to RF signals that are transmitted via the antennas 370a-370n.

The controller/processor 378 can include one or more processors or other processing devices that control the overall operation of the gNB 102. For example, the controller/processor 378 could control the reception of uplink (UL) channel signals and the transmission of downlink (DL) channel signals by the transceivers 372a-372n in accordance with well-known principles. The controller/processor 378 could support additional functions as well, such as more advanced wireless communication functions. For instance, the controller/processor 378 could support beam forming or directional routing operations in which outgoing/incoming signals from/to multiple antennas 370a-370n are weighted differently to effectively steer the outgoing signals in a desired direction. Any of a wide variety of other functions could be supported in the gNB 102 by the controller/processor 378.

The controller/processor 378 is also capable of executing programs and other processes resident in the memory 380, such as an OS and, for example, processes to support synchronous data transmission as discussed in greater detail below. The controller/processor 378 can move data into or out of the memory 380 as required by an executing process.

The controller/processor 378 is also coupled to the backhaul or network interface 382. The backhaul or network interface 382 allows the gNB 102 to communicate with other devices or systems over a backhaul connection or over a network. The interface 382 could support communications over any suitable wired or wireless connection(s). For example, when the gNB 102 is implemented as part of a cellular communication system (such as one supporting 5G/NR, LTE, or LTE-A), the interface 382 could allow the gNB 102 to communicate with other gNBs over a wired or wireless backhaul connection. When the gNB 102 is implemented as an access point, the interface 382 could allow the gNB 102 to communicate over a wired or wireless local area network or over a wired or wireless connection to a larger network (such as the Internet). The interface 382 includes any suitable structure supporting communications over a wired or wireless connection, such as an Ethernet or transceiver.

The memory 380 is coupled to the controller/processor 378. Part of the memory 380 could include a RAM, and another part of the memory 380 could include a Flash memory or other ROM.

Although FIG. 3B illustrates one example of gNB 102, various changes may be made to FIG. 3B. For example, the gNB 102 could include any number of each component shown in FIG. 3B. Also, various components in FIG. 3B could be combined, further subdivided, or omitted and additional components could be added according to particular needs.

In the next generation wireless communication system (e.g., 5G, beyond 5G (B5G), 6G) operating in higher frequency (mmWave) bands, UEs and gNBs communicate with each other using beamforming. Beamforming techniques are used to mitigate propagation path losses and to increase the propagation distance for communication at higher frequency bands. Beamforming enhances the transmission and reception performance using a high-gain antenna. Beamforming can be classified into Transmission (TX) beamforming performed in a transmitting end and reception (RX) beamforming performed in a receiving end. In general, TX beamforming increases directivity by allowing an area in which propagation reaches to be densely located in a specific direction by using a plurality of antennas. In this situation, aggregation of the plurality of antennas can be referred to as an antenna array, and each antenna included in the array can be referred to as an array element. The antenna array can be configured in various forms such as a linear array, a planar array, etc. The use of TX beamforming results in an increase in the directivity of a signal, thereby increasing the propagation distance. Further, since the signal is almost not transmitted in a direction other than a directivity direction, a signal interference acting on another receiving end is significantly decreased. The receiving end can perform beamforming on a RX signal by using a RX antenna array. RX beamforming increases the RX signal strength transmitted in a specific direction by allowing propagation to be concentrated in a specific direction, and excludes a signal transmitted in a direction other than the specific direction from the RX signal, thereby providing an effect of blocking an interference signal. By using beamforming techniques, a transmitter can generate a plurality of transmit beam patterns of different directions. Each of these transmit beam patterns can be also referred to as a transmit (TX) beam. A wireless communication system operating at high frequency uses a plurality of narrow TX beams to transmit signals in the cell, as each narrow TX beam provides coverage to a part of the cell. The narrower the TX beam, the higher the antenna gain and hence the larger the propagation distance of a signal transmitted using beamforming. A receiver can also generate a plurality of receive (RX) beam patterns of different directions. Each of these receive patterns can be also referred to as a receive (RX) beam.

The next generation wireless communication system (e.g., 5G, beyond 5G (B5G), 6G) supports standalone modes of operation as well dual connectivity (DC). In DC a multiple Rx/Tx UE may be configured to utilize resources provided by two different nodes (or NBs) connected via non-ideal backhaul. One node acts as the Master Node (MN) and the other as the Secondary Node (SN). The MN and SN are connected via a network interface and at least the MN is connected to the core network. NR also supports Multi-RAT Dual Connectivity (MR-DC) operation whereby a UE in an RRC_CONNECTED state is configured to utilize radio resources provided by two distinct schedulers, located in two different nodes connected via a non-ideal backhaul and providing either E-UTRA (i.e., if the node is an ng-eNB) or NR access (i.e., if the node is a gNB). In NR for a UE in an RRC_CONNECTED state not configured with carrier aggregation (CA)/DC there is only one serving cell comprising the primary cell. For a UE in an RRC CONNECTED state configured with CA/DC the term ‘serving cells’ is used to denote the set of cells comprising the Special Cell(s) (SpCell[s]) and all secondary cells. In NR the term Master Cell Group (MCG) refers to a group of serving cells associated with the Master Node, comprising the Primary cell (PCell) and optionally one or more Secondary Cells (SCells). In NR the term Secondary Cell Group (SCG) refers to a group of serving cells associated with the Secondary Node, comprising the Primary SCG Cell (PSCell) and optionally one or more SCells. In NR PCell refers to a serving cell in the MCG, operating on the primary frequency, in which the UE either performs the initial connection establishment procedure or initiates the connection re-establishment procedure. In NR for a UE configured with CA, an SCell is a cell providing additional radio resources on top of the Special Cell. PSCell refers to a serving cell in the SCG in which the UE performs random access when performing the Reconfiguration with Sync procedure. For Dual Connectivity operation the term SpCell refers to the PCell of the MCG or the PSCell of the SCG, otherwise the term Special Cell refers to the PCell.

In the next generation wireless communication system (e.g., 5G, beyond 5G (B5G), 6G), a node B (gNB) or base station in cell broadcast Synchronization Signal and PBCH block (SSB) comprises primary and secondary synchronization signals (PSS, SSS) and system information (SI). SI includes common parameters used to communicate in the cell. In the fifth generation wireless communication system (also referred to as next generation radio or NR), SI is divided into the master information block (MIB) and a number of system information blocks (SIBs) where the MIB is always transmitted on the broadcast channel (BCH) with a periodicity of 80 ms and repetitions made within 80 ms and it includes parameters that are used to acquire SIB1 from the cell. The SIB1 is transmitted on the downlink-shared channel (DL-SCH) with a periodicity of 160 ms and variable transmission repetition. The default transmission repetition periodicity of SIB1 is 20 ms but the actual transmission repetition periodicity is up to network implementation. For SSB and CORESET multiplexing pattern 1, the SIB1 repetition transmission period is 20 ms. For SSB and CORESET multiplexing pattern 2/3, the SIB1 transmission repetition period is the same as the SSB period. SIB1 includes information regarding the availability and scheduling (e.g., mapping of SIBs to SI messages, periodicity, SI-window size) of other SIBs with an indication whether one or more SIBs are only provided on-demand and, in that case, the configuration used by the UE to perform the SI request. SIB1 is a cell-specific SIB. SIBs other than SIB1 and positioning SIBs (posSIBs) are carried in SystemInformation (SI) messages, which are transmitted on the DL-SCH. Only SIBs or posSIBs having the same periodicity can be mapped to the same SI message. SIBs and posSIBs are mapped to different SI messages. Each SI message is transmitted within periodically occurring time domain windows (referred to as SI-windows with the same length for all SI messages). Each SI message is associated with an SI-window and the SI-windows of different SI messages do not overlap. That is, within one SI-window only the corresponding SI message is transmitted. An SI message may be transmitted a number of times within the SI-window. Any SIB or posSIB except SIB1 can be configured to be cell specific or area specific, using an indication in SIB1. The cell specific SIB is applicable only within a cell that provides the SIB while the area specific SIB is applicable within an area referred to as an SI area, which comprises one or several cells and is identified by systemInformationAreaID. The mapping of SIBs to SI messages is configured in schedulingInfoList, while the mapping of posSIBs to SI messages is configured in pos-SchedulingInfoList. Each SIB is contained only in a single SI message and each SIB and posSIB is contained at most once in that SI message. For a UE in an RRC CONNECTED state, the network can provide system information through dedicated signaling using the RR (Reconfiguration message (e.g., if the UE has an active BWP with no common search space configured to monitor system information), paging, or upon request from the UE. In an RRC_CONNECTED state, the UE acquires the SIB(s) only from a PCell. For PSCell and SCells, the network provides the required SI by dedicated signaling, (i.e., within an RRCReconfiguration message). Nevertheless, the UE acquires the MIB of the PSCell to get system frame number (SFN) timing of the SCG (which may be different from the MCG). Upon change of relevant SI for an SCell, the network releases and adds the concerned SCell. For a PSCell, the required SI can be changed with Reconfiguration with Sync.

In the next generation wireless communication system (e.g., 5G, beyond 5G (B5G), 6G), the Physical Downlink Control Channel (PDCCH) is used to schedule DL transmissions on the physical downlink shared channel (PDSCH) and UL transmissions on the physical uplink shared channel (PUSCH), where the Downlink Control Information (DCI) on the PDCCH includes: downlink assignments containing at least modulation and coding format, resource allocation, and hybrid-ARQ information related to DL-SCH; uplink scheduling grants containing at least modulation and coding format, resource allocation, and hybrid-ARQ information related to UL-SCH. In addition to scheduling, the PDCCH can be used to for: activation and deactivation of configured PUSCH transmission with configured grant; activation and deactivation of PDSCH semi-persistent transmission; notifying one or more UEs of the slot format; notifying one or more UEs of the physical resource block(s) (PRB[s]) and OFDM symbol(s) where the UE may assume no transmission is intended for the UE; transmission of TPC commands for the PUCCH and PUSCH; transmission of one or more TPC commands for sounding reference signal (SRS) transmissions by one or more UEs; switching a UE's active bandwidth part; and initiating a random access procedure. A UE monitors a set of PDCCH candidates in the configured monitoring occasions in one or more configured Control REsource SETs (CORESETs) according to the corresponding search space configurations. A CORESET comprises a set of PRBs with a time duration of 1 to 3 OFDM symbols. The resource units Resource Element Groups (REGs) and Control Channel Elements (CCEs) are defined within a CORESET with each CCE comprising a set of REGs. Control channels are formed by aggregation of CCEs. Different code rates for the control channels are realized by aggregating different numbers of CCEs. Interleaved and non-interleaved CCE-to-REG mapping is supported in a CORESET. Polar coding is used for the PDCCH. Each resource element group carrying the PDCCH carries its own demodulation reference signal (DMRS). QPSK modulation is used for the PDCCH.

In the next generation wireless communication system (e.g., 5G, beyond 5G (B5G), 6G), bandwidth adaptation (BA) is supported. With BA, the receive and transmit bandwidth of a UE need not be as large as the bandwidth of the cell and can be adjusted: the width can be ordered to change (e.g., to shrink during period of low activity to save power); the location can move in the frequency domain (e.g., to increase scheduling flexibility); and the subcarrier spacing can be ordered to change (e.g., to allow different services). A subset of the total cell bandwidth of a cell is referred to as a Bandwidth Part (BWP). BA is achieved by configuring an RRC connected UE with BWP(s) and telling the UE which of the configured BWPs is currently the active one. When BA is configured, the UE can monitor the PDCCH on only the one active BWP (i.e., the does not have to monitor the PDCCH on the entire DL frequency of the serving cell). In an RRC connected state, the UE is configured with one or more DL and UL BWPs, for each configured Serving Cell (i.e., PCell or SCell). For an activated Serving Cell, there is always one active UL and DL BWP at any point in time. BWP switching for a Serving Cell is used to activate an inactive BWP and deactivate an active BWP at a time. BWP switching is controlled by the PDCCH indicating a downlink assignment or an uplink grant, by the bwp-Inactivity Timer, by RRC signaling, or by the MAC entity itself upon initiation of a random access procedure. Upon addition of an SpCell or activation of an SCell, the DL BWP and UL BWP indicated by firstActiveDownlinkBWP-Id and firstActiveUplinkBWP-Id respectively is active without receiving a PDCCH indicating a downlink assignment or an uplink grant. The active BWP for a Serving Cell is indicated by either RRC or the PDCCH. For unpaired spectrum, a DL BWP is paired with a UL BWP, and BWP switching is common for both UL and DL. Upon expiry of the BWP inactivity timer, the UE switch the active DL BWP to the default DL BWP or initial DL BWP (if a default DL BWP is not configured).

In the next generation wireless communication system (e.g., 5G, beyond 5G (B5G), 6G), a list of search space configurations is signaled by the gNB for each configured BWP of the serving cell, wherein each search configuration is uniquely identified by a search space identifier. The search space identifier is unique amongst the BWPs of a serving cell. An identifier of search space configuration to be used for specific purpose such as paging reception, SI reception, random access response reception is explicitly signaled by the gNB for each configured BWP. In NR, a search space configuration comprises the parameters Monitoring-periodicity-PDCCH-slot, Monitoring-offset-PDCCH-slot, Monitoring-symbols-PDCCH-within-slot and duration. A UE determines PDCCH monitoring occasion(s) within a slot using the parameters PDCCH monitoring periodicity (Monitoring-periodicity-PDCCH-slot), the PDCCH monitoring offset (Monitoring-offset-PDCCH-slot), and the PDCCH monitoring pattern (Monitoring-symbols-PDCCH-within-slot). PDCCH monitoring occasions are in slots ‘x’ to x+duration, where the slot with number ‘x’ in a radio frame with number ‘y’ satisfies the equation below:

(y*(number of slots in a radio frame)+x-Monitoring-offset-PDCCH-slot)mod (Monitoring-periodicity-PDCCH-slot)=0.

The starting symbol of a PDCCH monitoring occasion in each slot having a PDCCH monitoring occasion is given by Monitoring-symbols-PDCCH-within-slot. The length (in symbols) of a PDCCH monitoring occasion is given in the CORESET associated with the search space. A search space configuration includes the identifier of a CORESET configuration associated with it. A list of coreset configurations are signaled by the gNB for each configured BWP of the serving cell, wherein each CORESET configuration is uniquely identified by a CORESET identifier. The CORESET identifier is unique amongst the BWPs of a serving cell. Note that each radio frame is of 10 ms duration. A radio frame is identified by a radio frame number or system frame number. Each radio frame comprises several slots, wherein the number of slots in a radio frame and duration of slots depends on sub carrier spacing. The number of slots in a radio frame and duration of slots for each supported SCS is pre-defined in NR. Each CORESET configuration is associated with a list of TCI (Transmission configuration indicator) states. One DL RS ID (SSB or CSI RS) is configured per TCI state. The list of TCI states corresponding to a CORESET configuration is signaled by the gNB via RRC signaling. One of the TCI states in TCI a state list is activated and indicated to the UE by the gNB. The TCI state indicates the DL TX beam (the DL TX beam is quasi co-located [QCLed] with the SSB/CSI RS of the TCI state) used by the gNB for transmission of the PDCCH in the PDCCH monitoring occasions of a search space.

In the next generation wireless communication system (e.g., 5G, beyond 5G (B5G), 6G), random access (RA) is supported. RA is used to achieve uplink (UL) time synchronization. RA is used during initial access, handover, radio resource control (RRC) connection re-establishment procedure, scheduling request transmission, secondary cell group (SCG) addition/modification, beam failure recovery and data or control information transmission in UL by non-synchronized UEs in an RRC CONNECTED state. Several types of random-access procedure are supported such as contention based random access, contention free random access and each of these can be one of 2 step or 4 step random access.

In the downlink, the gNB can dynamically allocate resources to UEs via the cell-radio network temporary identifier (C-RNTI) on PDCCH(s). A UE monitors the PDCCH(s) in order to find possible assignments when its downlink reception is enabled (activity governed by discontinuous reception [DRX] when configured). When CA is configured, the same C-RNTI applies to all serving cells.

The gNB may pre-empt an ongoing PDSCH transmission to one UE with a latency-critical transmission to another UE. The gNB can configure UEs to monitor interrupted transmission indications using an interruption-RNTI (INT-RNTI) on a PDCCH. If a UE receives the interrupted transmission indication, the UE may assume that no useful information to that UE was carried by the resource elements included in the indication, even if some of those resource elements were already scheduled to this UE.

In addition, with Semi-Persistent Scheduling (SPS), the gNB can allocate downlink resources for the initial hybrid automatic repeat request (HARQ) transmissions to UEs: RRC define the periodicity of the configured downlink assignments while PDCCH addressed to CS-RNTI can either signal and activate the configured downlink assignment, or deactivate it (i.e., a PDCCH addressed to CS-RNTI indicates that the downlink assignment can be implicitly reused according to the periodicity defined by RRC, until deactivated). When required, retransmissions are explicitly scheduled on PDCCH(s).

The dynamically allocated downlink reception overrides the configured downlink assignment in the same serving cell, if they overlap in time. Otherwise, a downlink reception according to the configured downlink assignment is assumed, if activated. The UE may be configured with up to 8 active configured downlink assignments for a given BWP of a serving cell. When more than one is configured:
The network decides which of these configured downlink assignments are active at for a particular time (including all of them); and
Each configured downlink assignment is activated separately using a DCI command, and configured downlink assignments are deactivated using a DCI command, which can either deactivate a single configured downlink assignment or multiple configured downlink assignments jointly.

Uplink scheduling: In the uplink, the gNB can dynamically allocate resources to UEs via the C-RNTI on PDCCH(s). A UE monitors the PDCCH(s) in order to find possible grants for uplink transmission when its downlink reception is enabled (activity governed by DRX when configured). When CA is configured, the same C-RNTI applies to all serving cells.

The gNB may cancel a PUSCH transmission, or a repetition of a PUSCH transmission, or an SRS transmission of a UE for another UE with a latency-critical transmission. The gNB can configure UEs to monitor canceled transmission indications using a cancellation indication-RNT (CI-RNTI) on a PDCCH. If a UE receives the canceled transmission indication, the UE shall cancel the PUSCH transmission from the earliest symbol overlapped with the resource or the SRS transmission overlapped with the resource indicated by the cancellation. In addition, with Configured Grants, the gNB can allocate uplink resources for the initial HARQ transmissions and HARQ retransmissions to UEs. Two types of configured uplink grants are defined:
With Type 1, RRC directly provides the configured uplink grant (including the periodicity).
With Type 2, RRC defines the periodicity of the configured uplink grant while PDCCH addressed to CS-RNTI can either signal and activate the configured uplink grant, or deactivate it (i.e., a PDCCH addressed to CS-RNTI indicates that the uplink grant can be implicitly reused according to the periodicity defined by RRC, until deactivated).

If the UE is not configured with enhanced intra-UE overlapping resources prioritization, the dynamically allocated uplink transmission overrides the configured uplink grant in the same serving cell, if they overlap in time. Otherwise, an uplink transmission according to the configured uplink grant is assumed, if activated.

If the UE is configured with enhanced intra-UE overlapping resources prioritization, in case a configured uplink grant transmission overlaps in time with dynamically allocated uplink transmission or with another configured uplink grant transmission in the same serving cell, the UE prioritizes the transmission based on the comparison between the highest priority of the logical channels (LCHs) that have data to be transmitted and which are multiplexed or can be multiplexed in MAC protocol data units (PDUs) associated with the overlapping resources. Similarly, in case a configured uplink grant transmission or a dynamically allocated uplink transmission overlaps in time with a scheduling request transmission, the UE prioritizes the transmission based on the comparison between the priority of the logical channel which triggered the scheduling request and the highest priority of the logical channels that have data to be transmitted and which are multiplexed or can be multiplexed in MAC PDU associated with the overlapping resource. In case the MAC PDU associated with a deprioritized transmission has already been generated, the UE keeps it stored to allow the gNB to schedule a retransmission. The UE may also be configured by the gNB to transmit the stored MAC PDU as a new transmission using a subsequent resource of the same configured uplink grant configuration when an explicit retransmission grant is not provided by the gNB. Retransmissions other than repetitions are explicitly allocated via PDCCH(s) or via configuration of a retransmission timer.

The UE may be configured with up to 12 active configured uplink grants for a given BWP of a serving cell. When more than one is configured, the network decides which of these configured uplink grants are active at a time (including all of them). Each configured uplink grant can either be of Type 1 or Type 2. For Type 2, activation and deactivation of configured uplink grants are independent among the serving cells. When more than one Type 2 configured grant is configured, each configured grant is activated separately using a DCI command and deactivation of Type 2 configured grants is done using a DCI command, which can either deactivate a single configured grant configuration or multiple configured grant configurations jointly.

When supplementary uplink (SUL) is configured, the network should ensure that an active configured uplink grant on SUL does not overlap in time with another active configured uplink grant on the other UL configuration.

For both dynamic grant and configured grant, for a transport block, two or more repetitions can be in one slot, or across a slot boundary in consecutive available slots with each repetition in one slot. For both dynamic grant and configured grant Type 2, the number of repetitions can also be dynamically indicated in the L1 signaling. The dynamically indicated number of repetitions shall override the RRC configured number of repetitions, if both are present.

In the next generation wireless communication system (e.g., 5G, beyond 5G (B5G), 6G), the UE has an uplink rate control function which manages the sharing of uplink resources between logical channels. RRC controls the uplink rate control function by giving each logical channel a priority, a prioritized bit rate (PBR), and a buffer size duration (BSD). In addition, mapping restrictions can be configured. With LCP restrictions in MAC, RRC can restrict the mapping of a logical channel to a subset of the configured cells, numerologies, PUSCH transmission durations, configured grant configurations and control whether a logical channel can utilize the resources allocated by a Type 1 Configured Grant or whether a logical channel can utilize dynamic grants indicating a certain physical priority level. With such restrictions, it then becomes possible to reserve, for instance, the numerology with the largest subcarrier spacing and/or shortest PUSCH transmission duration for URLLC services. Furthermore, RRC can associate logical channels with different scheduling request (SR) configurations, for instance, to provide more frequent SR opportunities to URLLC services.

The uplink rate control function ensures that the UE serves the logical channel(s) in the following sequence:
1. All relevant logical channels in decreasing priority order up to their PBR;
2. All relevant logical channels in decreasing priority order for the remaining resources assigned by the grant.

In case the PBRs are all set to zero, the first step is skipped, and the logical channels are served in strict priority order (i.e., the UE maximizes the transmission of higher priority data).

extended Reality (XR) is a term for different types of realities and refers to all real-and-virtual combined environments and human-machine interactions generated by computer technology and wearables. It includes the following representative forms, and the areas interpolated among them: Augmented Reality (AR); Mixed Reality (MR); Virtual Reality (VR). extended Reality (XR) services use high data rate and low latency communications.

In order to enhance the scheduling of uplink resources for XR, the following improvements have been introduced:
One additional buffer size table to reduce the quantization errors in BSR reporting (e.g., for high bit rates):
   Whether, for an LCG (Logical channel group), the new table can be used in addition to the regular one is configured by the gNB;
   When the new table is configured for an LCG, it is used whenever the amount of the buffered data of that LCG is within the range of the new table, otherwise the regular table is used.
Delay Status Report (DSR) of buffered data via a dedicated MAC CE (control element):
   Triggered for an LCG when the remaining time before discard of any buffered Packet data convergence protocol (PDCP) SDU goes below a configured threshold (threshold configured per LCG by the gNB);
   When triggered for an LCG, reports the amount of data buffered with a remaining time before discard below the configured threshold, together with the shortest remaining time of any PDCP SDU buffered.
Reporting of uplink assistance information (jitter range, burst arrival time, UL data burst periodicity) per quality of service (QOS) flow by the UE via UE Assistance Information.

A PDU Set is one or more PDUs carrying the payload of one unit of information generated at the application level (e.g., frame(s) or video slice(s) for XR Services). The following PDU Set QoS Parameters may be provided by the SMF to the gNB as part of the QoS profile of the QoS flow, and to enable PDU Set based QoS handling at least one of them shall be provided:
PDU Set Delay Budget (PSDB): upper bound for the duration between the reception time of the first PDU (at the UPF for DL, at the UE for UL) and the time when all PDUs of a PDU Set have been successfully received (at the UE in DL, at the UPF in UL). A QOS Flow is associated with only one PSDB, and when available, it applies to both DL and UL and supersedes the PDB of the QoS flow.
PDU Set Error Rate (PSER): upper bound for a rate of non-congestion related PDU Set losses between RAN and the UE. A QoS Flow is associated with only one PSER, and when available, it applies to both DL and UL and supersedes the PER of the QoS flow.
PDU Set Integrated Handling Information (PSIHI): indicates whether all PDUs of the PDU Set are used for the usage of PDU Set by application layer.

When the PDU Set Integrated Handling Information (PSIHI) is set for a QoS flow, as soon as one PDU of a PDU set is known to be lost, the remaining PDUs of that PDU Set can be considered as no longer used by the application and may be subject to discard operation at the transmitter to free up radio resources.

In uplink, the UE may be configured with a PDU Set based discard operation for a specific DRB. When configured, the UE discards all packets in a PDU set when one PDU belonging to this PDU set is discarded due to a discard timer expiry. The gNB may perform downlink PDU Set discarding based on implementation by taking at least PSDB (PDU Set Delay Budget), PSI (PDU Set Importance), PSIHI parameters into account. In case of congestion, the gNB may use the PSI for PDU set discarding. For uplink, dedicated downlink signaling is used to request the UE to apply a shorter discard timer to low importance SDUs in PDCP.

Further evolution of XR is expected to consider more advanced and demanding XR use cases. Some of these use cases include localized mobile metaverse service, synchronized predictive avatars, and virtual humans in the metaverse. Further enhancement for XR should consider requirements to support XR applications with multi-modal flows. The new requirements expected to be supported when handling multiple correlated flows in UL/DL include multi-modal synchronization threshold (≤15 ms) and RTT latency (≤20 ms). One important aspect of multi-modality and its relation to user experience is the transmission/reception of data in dependent flows within the synchronization threshold. Various embodiments of the present disclosure provide mechanisms that enable resource scheduling and data transmissions in multi-modal flows within the synchronization threshold.

The next generation wireless communication system (e.g., 5G, beyond 5G (B5G), 6G) supports time division duplex (TDD) operation and frequency division duplex (FDD) operation. Use of FDD or TDD depends on the frequency band and per-country allocations. TDD is used in most bands above 2.5 GHz. TDD can have number of advantages over FDD. For example, use of the same band for DL and UL transmissions leads to simpler UE implementation with TDD because a duplexer is not required. Another advantage is that time resources can be flexibly assigned to UL and DL considering an asymmetric ratio of traffic in both directions. DL is typically assigned the most time resources in TDD to handle DL-heavy mobile traffic. Another advantage is that channel state information (CSI) can be more easily acquired via channel reciprocity. This reduces an overhead associated with CSI reports, especially when there is a large number of antennas.

Although there are advantages of TDD over FDD, there are also disadvantages. A first disadvantage is a smaller coverage of TDD due to the usually small portion of time resources available for UL transmissions, while with FDD all time resources can be used for UL transmissions. Another disadvantage is latency. In TDD, a timing gap between DL reception and UL transmission containing the hybrid automatic repeat request acknowledgement (HARQ-ACK) information associated with DL receptions is typically larger than that in FDD, for example by several milliseconds. Therefore, the HARQ round trip time in TDD is typically longer than that with FDD, especially when the DL traffic load is high. This causes increased UL user plane latency in TDD and can cause data throughput loss or even HARQ stalling when a PUCCH providing HARQ-ACK information needs to be transmitted with repetitions in order to improve coverage (an alternative in such case is for a network to forgo HARQ-ACK information at least for some transport blocks in the DL).

To address some of the disadvantages for TDD operation, a dynamic adaptation of link direction has been considered where, with the exception of some symbols in some slots supporting predetermined transmissions such as for SSBs, symbols of a slot can have a flexible direction (UL or DL) that a UE can determine according to scheduling information for transmissions or receptions. Full-duplex (FD) communications offer a potential for increased spectral efficiency, improved capacity, and reduced latency in wireless networks. When using FD communications, UL and DL signals are simultaneously received and transmitted on fully or partially overlapping, or adjacent, frequency resources, thereby improving spectral efficiency and reducing latency in user and/or control planes.

It is one recognized and reported problem in TDD network deployments that TDD mode results in significantly increased initial access delays due to the Registration procedures when compared to FDD networks. In the case of LTE FDD, the overall duration of the Attach procedure beginning with PSS/SSS acquisition and ending with successful PDU session establishment by the UE is found to be in the order of around 100-110 msec under good signal conditions.

For TDD network deployments operating in standalone (SA) mode, significantly higher initial access delays are observed. The overall duration of the registration procedure is much longer (e.g., up to 250-300 msec). This is due to two underlying reasons. Usually, TDD has fewer UL than DL transmission opportunities in a UL-DL frame period than FDD. Additional transmission delay is incurred in TDD networks (1) by the DL-UL frame alignment delay and (2) a longer duration to complete the DL and UL transmission sequence when compared to FDD networks.

Full duplexing or subband full duplexing can reduce the access latency by scheduling the UE in full duplex/SBFD symbols/slots. However, UE-side enhancements in support of full-duplex operation at the gNB are signaled using the RRC UE capability procedure. It is only after the RRC UE Capability Information msg (UL) has been received by the gNB and after the resulting RRC Connection Reconfiguration message exchange in DL and UL has been completed that the gNB can start making use of optimized scheduling and channel assignments for the UE considering the Full duplexing or subband full duplexing capability. Early Indication methods by full duplexing or subband full duplexing capable UEs in Msg3 (of the 4-step RACH procedure) and MsgA (of the 2-step RACH procedure) are desirable. Early Indication (e.g., prior to the RRC UE Capability signaling exchange) is provided by the UE to the network that the UE supports full duplexing or subband full duplexing. It is considered that a logical channel ID (LCID) can be reserved for reporting full duplexing or subband full duplexing capability and this LCID is used in MAC PDU carrying the initial uplink message (CCCH) to gNB in Msg3 or MsgA. One LCID is not enough, as UE may have to report other early indications such as PUCCH repetition of Msg4 HARQ-ACK, Redcap, eRedcap etc. Various embodiments of the present disclosure provide for additional LCIDs for reporting full duplexing or subband full duplexing capability.

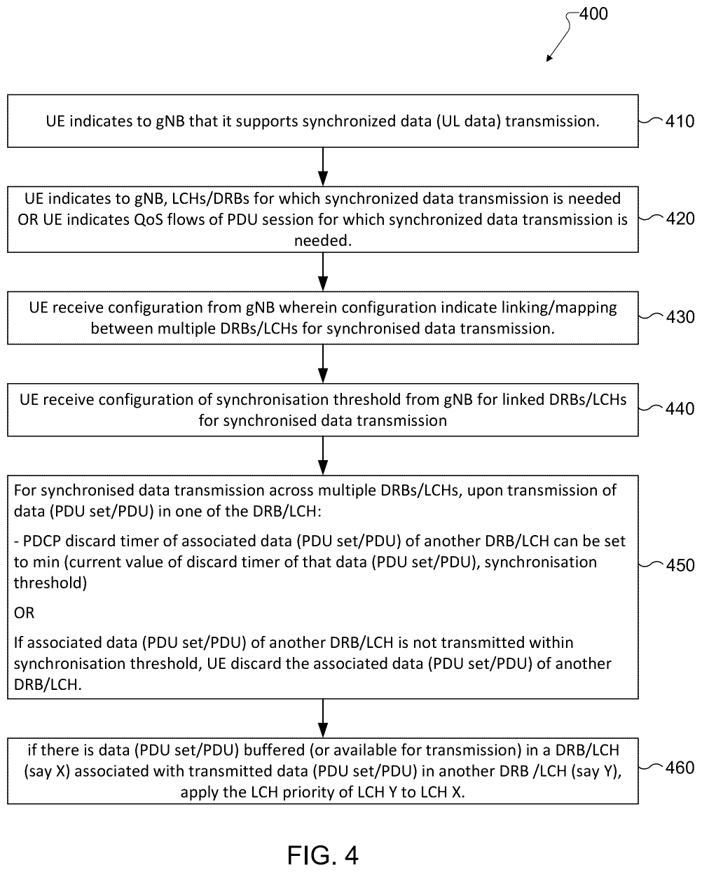

FIG. 4 illustrates an example method for synchronized data transmission 400 according to embodiments of the present disclosure. An embodiment of the method illustrated in FIG. 4 is for illustration only. One or more of the components illustrated in FIG. 4 may be implemented in specialized circuitry configured to perform the noted functions or one or more of the components may be implemented by one or more processors executing instructions to perform the noted functions. Other embodiments of a method for synchronized data transmission could be used without departing from the scope of this disclosure.

In the example of FIG. 4, method 400 begins at step 410. At step 410, a UE (such as UE 116 of FIG. 1) may indicate to a gNB (such as BS 102 of FIG. 1) that the UE supports synchronized data (UL data) transmission. In some embodiments, the UE may include this capability info in an RRC message (e.g., a UE capability information message) or in a MAC CE. In some embodiments, this capability can be indicated per UE or per frequency/carrier or per frequency band. In some embodiments, the UE may send this indication upon request from the gNB. In some embodiments, the UE may send this indication during the connection setup/resume procedure. In some embodiments, the UE may send this indication upon entering an RRC CONNECTED state.

An XR application can comprise ‘N’ multi modal data flows, where N is an integer greater than 1. These multi modal data flows can be mapped to multiple data radio bearers (DRBs) and/or multiple logical channels (LCHs). For example, if there are two multi data flows, one data flow can be mapped to DRB1/LCH 1 and another data flow can be mapped to DRB2/LCH 2.

In some embodiments, at step 420, the UE may indicate, to the gNB, LCHs/DRBs for which synchronized data transmission is sought.

Alternatively, in some embodiments, at step 420 the UE may indicate QoS flows of a PDU session for which synchronized data transmission is sought.

Alternatively, in some embodiments, the gNB may indicate QoS flows of a PDU session for which synchronized data transmission is sought. Based on QoS flows to DRB mapping for the PDU session, at step 420 the UE can then identify the DRBs for which synchronized data transmission is sought.

In some embodiments, at step 430, the UE may receive a message (e.g., an RRC message such as RRC Reconfiguration) from the gNB, wherein the configuration indicates linking/mapping between multiple DRBs/LCHs for synchronized data transmission. In other words, the RRC message indicates for which LCHs/DRBs synchronized data transmission is performed/enabled/supported. For example, if there are two multi data flows for an XR application and these are mapped to DRB1/LCH 1 and DRB2/LCH 2, the configuration may indicate that synchronized data transmission is performed/enabled/supported for DRB1/LCH 1 and DRB2/LCH 2. Configuration of a DRB/LCH (e.g., DRB1/LCH 1 configuration) may include a DRB ID/LCH ID of a linked DRB/LCH (e.g., DRB 2/LCH 2).

In some embodiments, for synchronized data transmission across multiple DRBs/LCHs, data in one DRB/LCH should be transmitted within X ms of transmission of data in other DRB/LCH. For example, for synchronized data transmission across DRB1/LCH 1 and DRB2/LCH 2, data in DRB2/LCH 2 should be transmitted within X ms of transmission of data in DRB1/LCH 1. In some embodiments, at step 440, the synchronization threshold can be received by the UE from the gNB via a message (e.g., an RRC message such as RRC Reconfiguration). In some embodiments, the configuration can be provided together with linking/synchronization information. In some embodiments, the synchronization threshold can be common for all sets of linked DRBs/LCHs or can be separate for each set. For example, assume synchronized data transmission is configured for a) DRB1/LCH 1 and DRB2/LCH 2; and b) DRB3/LCH 3 and DRB4/LCH 4. The synchronization threshold can be separately configured for a) and b), or the synchronization threshold can be commonly configured for a) and b). In some embodiments, the synchronization threshold can be received by the UE from an upper layer (application layer) or NAS signaling from the core network.

For DRBs/LCHs configured for synchronized data transmission, multiple PDU sets can be transmitted by each DRB/LCH. Association between PDU sets of DRBs/LCHs configured with synchronized data transmission is desirable. Amongst the DRBs/LCHs for which synchronized data transmission is enabled:
A PDU set with SN A in one DRB/LCH can be associated with a PDU set with SN A in another DRB/LCH
A PDU set with SN A in one DRB can be associated with a PDU set with SN B in another DRB.
   The association information can be received from an upper layer. For a PDU set of a DRB/LCH, the upper layer can indicate associated PDU set(s) and DRBs/LCHs.

In some embodiments, at step 450, for synchronized data transmission across multiple DRBs/LCHs, upon transmission of data (PDU set/PDU) in one of the DRBs/LCHs:
A PDCP discard timer of associated data (PDU set/PDU) of another DRB/LCH can be set to the minimum of a current value of a discard timer of that data (PDU set/PDU) and the synchronization threshold. In other words, the PDCP discard time is set to the lower of the current value of the discard time of the associated data or the synchronization threshold.

For example, for synchronized data transmission across DRB1/LCH 1 and DRB2/LCH 2, upon transmission of data (PDU set/PDU) of DRB1/LCH 1:
The PDCP discard timer of associated data (PDU set) of DRB2/LCH 2 can be set to the minimum of a current value of a discard timer of that data and the synchronization threshold

Alternatively, in some embodiments, at step 450, for synchronized data transmission across multiple DRBs/LCHs, upon transmission of data (PDU set/PDU) in one of the DRB/LCH:
If associated data (PDU set/PDU) of another DRB/LCH is not transmitted within the synchronization threshold, the UE discards the associated data (PDU set/PDU) of another DRB/LCH.

For example, for synchronized data transmission across DRB1/LCH 1 and DRB2/LCH 2, upon transmission of data (PDU set/PDU) of DRB1/LCH 1:
If associated data (PDU set/PDU) of DRB2/LCH 2 is not transmitted within the synchronization threshold, the UE discards the associated data (PDU set/PDU) of DRB2/LCH 2

In some embodiments, at step 460, for synchronized data transmission, the UE may apply the following rule for multiplexing data from various logical channels in a MAC PDU for transmission in an UL grant:
(if synchronized data transmission is configured and) if there is data (PDU set/PDU) buffered (or available for transmission) in a DRB/LCH (e.g., “X”) associated with transmitted data (PDU set/PDU) in another DRB/LCH (e.g., “Y”), apply the LCH priority of LCH Y to LCH X.
   For example, for synchronized data transmission across DRB1/LCH 1 and DRB2/LCH 2, if there is data (PDU set/PDU) buffered (or available for transmission) in DRB2/LCH 2 associated with transmitted data (PDU set) in DRB 1/LCH 1, the LCH priority of LCH 2 is applied to LCH 1

Alternatively, in some embodiments, at step 460, for synchronized data transmission, the UE may apply the following rule for multiplexing data from various logical channels in a MAC PDU for transmission in an UL grant:
For LCHs/DRBs configured for synchronized data transmission, if there is a LCH/DRB which has data buffered (or available for transmission) associated with transmitted data in linked LCH(s)/DRBs(s), the UE multiplexes data from this LCH/DRB first. If there are multiple such LCHs/DRBs, the UE multiplexes data from these in increasing order of (shortest) remaining value of discard timer. The UE then multiplexes data from other LCHs/DRBs having data available for transmission as per legacy procedure (e.g., the logical channels are first multiplexed in decreasing priority order up to their PBR; then the logical channels are multiplexed in decreasing priority order for the remaining resources [if any] assigned by the grant), as described herein.
OR
For LCHs/DRBs configured for synchronized data transmission and which have data buffered (or available for transmission) associated with transmitted data in linked LCHs/DRBs, the UE multiplexes data from these LCHs/DRBs in increasing order of LCH priority. The UE then multiplexes data from other LCHs/DRBs having data available for transmission as per legacy procedure (e.g., the logical channels are first multiplexed in decreasing priority order up to their PBR; then the logical channels are multiplexed in decreasing priority order for the remaining resources [if any] assigned by the grant), as described herein.

Although FIG. 4 illustrates one example method for synchronized data transmission 400, various changes may be made to FIG. 4. For example, while shown as a series of steps, various steps in FIG. 4 could overlap, occur in parallel, occur in a different order, occur any number of times, be omitted, or replaced by other steps.

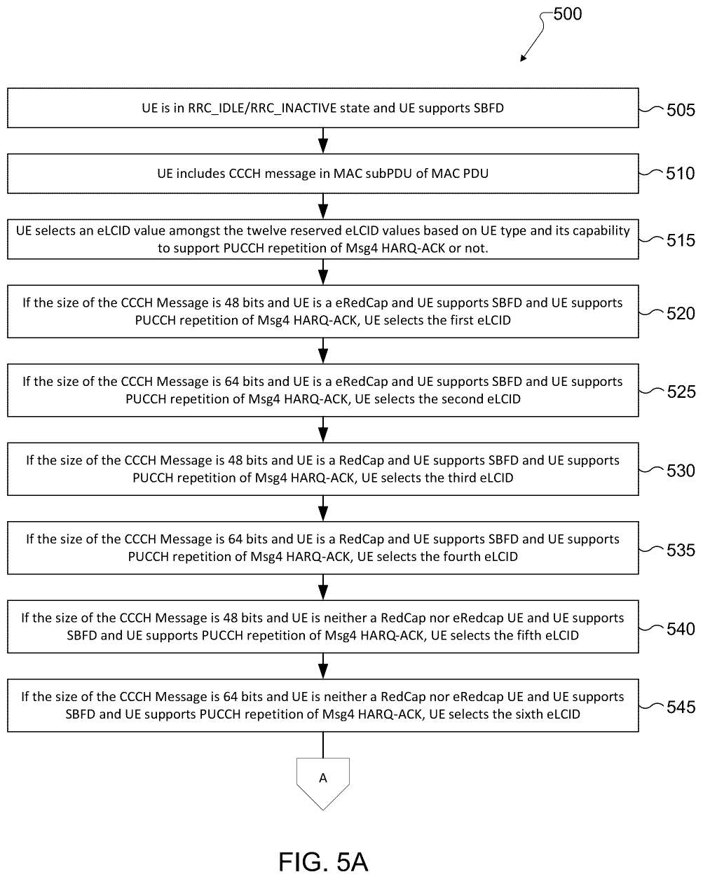

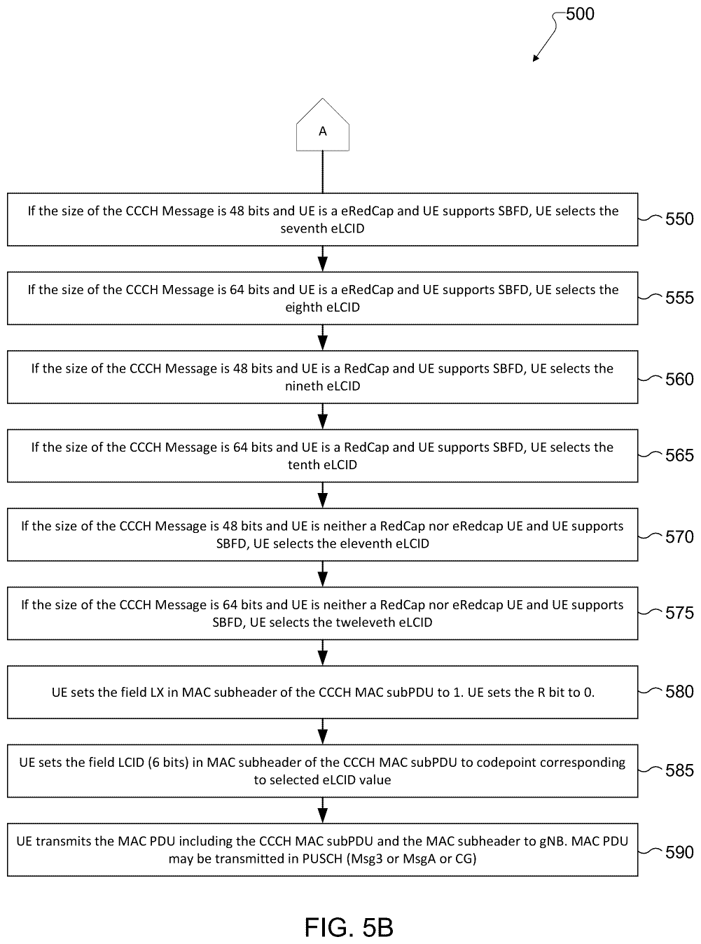

FIGS. 5A-5B illustrate an example method for UE capability indication 500 according to embodiments of the present disclosure. An embodiment of the method illustrated in FIGS. 5A-5B is for illustration only. One or more of the components illustrated in FIGS. 5A-5B may be implemented in specialized circuitry configured to perform the noted functions or one or more of the components may be implemented by one or more processors executing instructions to perform the noted functions. Other embodiments of a method for UE capability indication could be used without departing from the scope of this disclosure.

FIGS. 5A-5B show an example of a UE (such as UE 116 of FIG. 1) indicating the UE's capability of supporting full duplexing or subband full duplexing (SBFD) to a gNB (such as BS 102 of FIG. 1).

In some embodiments, up to 12 extended LCIE (eLCID) values can be reserved for a UE supporting full duplexing or subband full duplexing. In these embodiments, An eLCID is reserved for each of the following:
common control channel (CCCH) of size 48 bits for a UE supporting SubBand non-overlapping Full Duplex (SBFD) (or full duplexing), except for a reduced capability (RedCap) UE or an enhanced RedCap (eRedCap) UE
CCCH of size 64 bits for UE supporting SBFD (or full duplexing), except for an (e) RedCap UECCCH of size 48 bits for a RedCap UE supporting SBFD (or full duplexing)
CCCH of size 64 bits for a RedCap UE supporting SBFD (or full duplexing)
CCCH of size 48 bits for an eRedCap UE supporting SBFD (or full duplexing)
CCCH of size 64 bits for an eRedCap UE supporting SBFD (or full duplexing)
CCCH of size 48 bits for a UE supporting SBFD (or full duplexing) and PUCCH repetition of Msg4 HARQ-ACK, except for an (e) RedCap UE
CCCH of size 64 bits for a UE supporting SBFD (or full duplexing) and PUCCH repetition of Msg4 HARQ-ACK, except for an (e) RedCap UE
CCCH of size 48 bits for a RedCap UE supporting SBFD (or full duplexing) and PUCCH repetition of Msg4 HARQ-ACK
CCCH of size 64 bits for a RedCap UE supporting SBFD (or full duplexing) and PUCCH repetition of Msg4 HARQ-ACK
CCCH of size 48 bits for an eRedCap UE supporting SBFD (or full duplexing) and PUCCH repetition of Msg4 HARQ-ACK
CCCH of size 64 bits for an eRedCap UE supporting SBFD (or full duplexing) and PUCCH repetition of Msg4 HARQ-ACK

In some embodiments, 12 eLCID values can be reserved in between (216+328) to (216+383).

One example of a reservation of 12 eLCID values is shown in Table 1. The order in which the 12 eLCID values are mapped for various purposes can be different than those indicated in the table. All possible combinations are not listed for brevity.

TABLE 1

| Codepoint | Index | LCID values |
|---|---|---|
| 0 | (2¹⁶ + 320) | CCCH of size 48 bits for an eRedCap UE |
| 1 | (2¹⁶ + 321) | CCCH of size 64 bits for an eRedCap UE |
| 2 | (2¹⁶ + 322) | CCCH of size 48 bits for PUCCH repetition |
| | | of Msg4 HARQ-ACK, except for an |
| | | (e)RedCap UE |
| 3 | (2¹⁶ + 323) | CCCH of size 64 bits for PUCCH repetition |
| | | of Msg4 HARQ-ACK, except for an |
| | | (e)RedCap UE |
| 4 | (2¹⁶ + 324) | CCCH of size 48 bits for PUCCH repetition |
| | | of Msg4 HARQ-ACK of a RedCap UE |
| 5 | (2¹⁶ + 325) | CCCH of size 64 bits for PUCCH repetition |
| | | of Msg4 HARQ-ACK of a RedCap UE |
| 6 | (2¹⁶ + 326) | CCCH of size 48 bits for PUCCH repetition |
| | | of Msg4 HARQ-ACK of an eRedCap UE |
| 7 | (2¹⁶ + 327) | CCCH of size 64 bits for PUCCH repetition |
| | | of Msg4 HARQ-ACK of an eRedCap UE |
| 8 | (2¹⁶ + 328) | CCCH of size 48 bits for UE supporting |
| | | SBFD (or full duplexing), except for an |
| | | (e)RedCap UE |
| 9 | (2¹⁶ + 329) | CCCH of size 64 bits for UE supporting |
| | | SBFD (or full duplexing), except for an |
| | | (e)RedCap UE |
| 10 | (2¹⁶ + 330) | CCCH of size 48 bits for RedCap UE |
| | | supporting SBFD (or full duplexing) |
| 11 | (2¹⁶ + 331) | CCCH of size 64 bits for RedCap UE |
| | | supporting SBFD (or full duplexing) |
| 12 | (2¹⁶ + 332) | CCCH of size 48 bits for eRedCap UE |
| | | supporting SBFD (or full duplexing) |
| 13 | (2¹⁶ + 333) | CCCH of size 64 bits for eRedCap UE |
| | | supporting SBFD (or full duplexing) |
| 14 | (2¹⁶ + 334) | CCCH of size 48 bits for UE supporting |
| | | SBFD (or full duplexing) and PUCCH |
| | | repetition of Msg4 HARQ-ACK, except for |
| | | an (e)RedCap UE |
| 15 | (2¹⁶ + 335) | CCCH of size 64 bits for UE supporting |
| | | SBFD (or full duplexing) and PUCCH |
| | | repetition of Msg4 HARQ-ACK, except for |
| | | an (e)RedCap UE |
| 16 | (2¹⁶ + 336) | CCCH of size 48 bits for RedCap UE |
| | | supporting SBFD (or full duplexing) and |
| | | PUCCH repetition of Msg4 HARQ-ACK |
| 17 | (2¹⁶ + 337) | CCCH of size 64 bits for RedCap UE |
| | | supporting SBFD (or full duplexing) and |
| | | PUCCH repetition of Msg4 HARQ-ACK |
| 18 | (2¹⁶ + 338) | CCCH of size 48 bits for eRedCap UE |
| | | supporting SBFD (or full duplexing) and |
| | | PUCCH repetition of Msg4 HARQ-ACK |
| 19 | (2¹⁶ + 339) | CCCH of size 64 bits for eRedCap UE |
| | | supporting SBFD (or full duplexing) and |
| | | PUCCH repetition of Msg4 HARQ-ACK |
| 20 to 63 | (2¹⁶ + 340) to | Reserved |
| | (2¹⁶ + 383) | |

NOTE 1:
The MAC entity may use the code point corresponding to a given feature or feature combination in Table 1 only if the network indicates support for the corresponding feature or feature combination.
NOTE 2:
CCCH of size 48 bits and CCCH of size 64 bits are referred to as CCCH and CCCH1, respectively
NOTE 3:
For a UE capable of PUCCH repetition of Msg4 HARQ-ACK, the MAC entity uses the code points corresponding to PUCCH repetition of Msg4 HARQ-ACK if numberOfMsg4HARQ-ACK-Repetitions is configured, and if rsrp-ThresholdMsg4HARQ-ACK is configured, the RSRP of the downlink pathloss reference is less than rsrp-ThresholdMsg4HARQ-ACK.
NOTE 3:
In some embodiments, for a UE capable of SBFD, the MAC entity/UE uses the code points corresponding to SBFD if SBFD is configured, and if rsrp-ThresholdSBFD is configured, the RSRP of the downlink pathloss reference is less than rsrp-ThresholdSBFD. In some embodiments, for a UE capable of SBFD, the MAC entity/UE uses the code points corresponding to SBFD if SBFD is configured.

In the example of FIGS. 5A-5B, method 500 begins at step 505. At step 505, the UE is in an RRC_IDLE/RRC_INACTIVE state and the UE supports full duplexing or subband full duplexing (SBFD). The UE also initiates a connection setup/resume procedure.

At step 510, the UE includes a CCCH message in a MAC subPDU of a MAC PDU.

At step 515, the UE selects an eLCID value amongst the twelve reserved eLCID values discussed herein based on the UE type and the UE's capability (or lack thereof) to support PUCCH repetition of a Msg4 HARQ-ACK.

At step 520, if: (1) the size of the CCCH message is 48 bits; and (2) the UE is an eRedCap UE; and (3) the UE supports SBFD (or full duplexing); and (4) the UE supports PUCCH repetition of Msg4 HARQ-ACK, the UE selects a first eLCID (e.g., an eLCID similar as described regarding codepoint 18 of Table 1).

At step 525, if: (1) the size of the CCCH Message is 64 bits; and (2) the UE is an eRedCap UE; and (3) the UE supports SBFD (or full duplexing); and (4) the UE supports PUCCH repetition of a Msg4 HARQ-ACK, the UE selects a second eLCID (e.g., an eLCID similar as described regarding codepoint 19 of Table 1).

At step 530, if: (1) the size of the CCCH Message is 48 bits; and (2) the UE is a RedCap UE; and (3) the UE supports SBFD (or full duplexing); and (4) the UE supports PUCCH repetition of a Msg4 HARQ-ACK, the UE selects a third eLCID (e.g., an eLCID similar as described regarding codepoint 16 of Table 1).

At step 535, if: (1) the size of the CCCH Message is 64 bits; and (2) the UE is a RedCap UE; and (3) the UE supports SBFD (or full duplexing); and (4) the UE supports PUCCH repetition of a Msg4 HARQ-ACK, the UE selects a fourth eLCID (e.g., an eLCID similar as described regarding codepoint 17 of Table 1).

At step 540, if: (1) the size of the CCCH Message is 48 bits; and (2) the UE is neither a RedCap nor an eRedcap UE; and (3) the UE supports SBFD (or full duplexing); and (4) the UE supports PUCCH repetition of a Msg4 HARQ-ACK, the UE selects a fifth eLCID (e.g., an eLCID similar as described regarding codepoint 14 of Table 1).

At step 545, if: (1) the size of the CCCH Message is 64 bits; and (2) the UE is neither a RedCap nor an eRedcap UE; and (3) the UE supports SBFD (or full duplexing) and; (4) the UE supports PUCCH repetition of a Msg4 HARQ-ACK, the UE selects a sixth eLCID (e.g., an eLCID similar as described regarding codepoint 15 of Table 1).

At step 550, if: (1) the size of the CCCH Message is 48 bits; and (2) the UE is an eRedCap UE; and (3) the UE supports SBFD (or full duplexing), the UE selects a seventh eLCID (e.g., an eLCID similar as described regarding codepoint 12 of Table 1).

At step 555, if: (1) the size of the CCCH Message is 64 bits; and (2) the UE is an eRedCap UE; and (3) the UE supports SBFD (or full duplexing), the UE selects an eighth eLCID (e.g., an eLCID similar as described regarding codepoint 13 of Table 1).

At step 560, if: (1) the size of the CCCH Message is 48 bits; and (2) the UE is a RedCap UE; and (3) the UE supports SBFD (or full duplexing), the UE selects a ninth eLCID (e.g., an eLCID similar as described regarding codepoint 10 of Table 1).

At step 565, if: (1) the size of the CCCH Message is 64 bits; and (2) the UE is a RedCap UE; and (3) the UE supports SBFD (or full duplexing), the UE selects a tenth eLCID (e.g., an eLCID similar as described regarding codepoint 11 of Table 1).

At step 570, if (1) the size of the CCCH Message is 48 bits; and (2) the UE is neither a RedCap nor an eRedcap UE; and (3) the UE supports SBFD (or full duplexing), the UE selects an eleventh eLCID (e.g., an eLCID similar as described regarding codepoint 8 of Table 1).

At step 575, if (1) the size of the CCCH Message is 64 bits; and (2) the UE is neither a RedCap nor an eRedcap UE; and (3) the UE supports SBFD (or full duplexing), the UE selects a twelfth eLCID (e.g., an eLCID similar as described regarding codepoint 9 of Table 1).

At step 580, the UE sets the field LX in the MAC subheader of the CCCH MAC subPDU to 1. The UE also sets the R bit to 0.

At step 585, the UE sets the field LCID (6 bits) in the MAC subheader of the CCCH MAC subPDU to a codepoint corresponding to selected eLCID value.

At step 590, the UE transmits the MAC PDU including the CCCH MAC subPDU and the MAC subheader to the gNB. The MAC PDU may be transmitted in a PUSCH (Msg3 or MsgA or CG).

After step 590, the network determines the UE capability based on the received MAC PDU and accordingly schedules the UE.

Although FIGS. 5A-5B illustrate one example method for UE capability indication 500, various changes may be made to FIGS. 5A-5B. For example, while shown as a series of steps, various steps in FIGS. 5A-5B could overlap, occur in parallel, occur in a different order, occur any number of times, be omitted, or replaced by other steps.

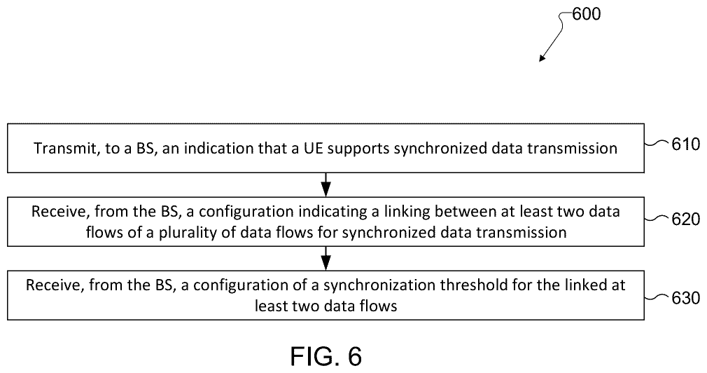

FIG. 6 illustrates another example method for synchronized data transmission 600 according to embodiments of the present disclosure. An embodiment of the method illustrated in FIG. 6 is for illustration only. One or more of the components illustrated in FIG. 6 may be implemented in specialized circuitry configured to perform the noted functions or one or more of the components may be implemented by one or more processors executing instructions to perform the noted functions. Other embodiments of a method for synchronized data transmission could be used without departing from the scope of this disclosure.

In the example of FIG. 6, method 600 begins at step 610. At step 610, a UE (such as UE 116 of FIG. 1) transmits, to a BS (such as BS 102 of FIG. 2), an indication that the UE supports synchronized data transmission.

In some embodiments, the UE may receive, from the BS, a message requesting a capability of the UE to support synchronized data transmission. In these embodiments, the indication that the UE supports synchronized data transmission may be transmitted in response to receiving the message.

At step 620, the UE receives, from the BS, a configuration indicating a linking between at least two data flows of a plurality of data flows for synchronized data transmission.

In some embodiments, the configuration indicating the linking between the plurality of data flows for synchronized data transmission may be included in an RRC reconfiguration message.

In some embodiments, the UE may transmit, to the BS a message including one of a plurality of data flows for which synchronized data transmission is requested, wherein each data flow of the plurality of data flows is one of a DRB or an LCH, and QoS flows of a protocol data unit (PDU) session for which synchronized data transmission is requested. In these embodiments, the UE may receive the configuration indicating the linking between the plurality of data flows in response to transmission of the message.

At step 630, the UE receives, from the BS, a configuration of a synchronization threshold for the linked at least two data flows.

In some embodiments, upon transmission of a data packet in a first data flow of the linked at least two data flows, the UE may set a PDCP discard timer of an associated data packet of a second data flow of the linked at least two data flows to a minimum of a current value of a discard timer and the synchronization threshold.

In some embodiments, upon transmission of a data packet in a first data flow of the linked at least two data flows, the UE may determine whether an associated data packet of a second data flow of the linked at least two data flows is transmitted within the synchronization threshold In response to a determination that the associated data packet is not transmitted within the synchronization threshold, the UE may discard the associated data packet.

In some embodiments, the UE may determine whether a data packet associated with a data packet transmitted in a first data flow of the linked at least two data flows is buffered or available for transmission in a second data flow of the linked at least two data flows. In response to a determination that the data packet associated with the data packet transmitted in the first data flow is buffered or available for transmission in the second data flow, the UE may apply a priority of the first data flow to the second data flow.

In some embodiments, the UE may determine whether a data packet associated with a data packet transmitted in a first data flow of the linked at least two data flows is buffered or available for transmission in another data flow of the linked at least two data flows. In response to a determination that the data packet associated with the data packet transmitted in the first data flow is buffered or available for transmission in the other data flow of the linked at least two data flows, the UE may prioritize multiplexing the data packet from the other data flow of the linked at least two data flows before multiplexing data packets from data flows not linked to the first data flow.

Although FIG. 6 illustrates one example method for synchronized data transmission 600, various changes may be made to FIG. 6. For example, while shown as a series of steps, various steps in FIG. 6 could overlap, occur in parallel, occur in a different order, occur any number of times, be omitted, or replaced by other steps.

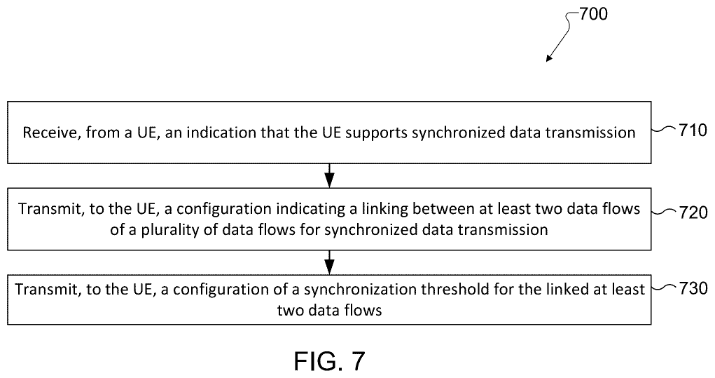

FIG. 7 illustrates another example method for synchronized data transmission 700 according to embodiments of the present disclosure. An embodiment of the method illustrated in FIG. 7 is for illustration only. One or more of the components illustrated in FIG. 7 may be implemented in specialized circuitry configured to perform the noted functions or one or more of the components may be implemented by one or more processors executing instructions to perform the noted functions. Other embodiments of a method for synchronized data transmission could be used without departing from the scope of this disclosure.

In the example of FIG. 7, method 700 begins at step 710. At step 710, a BS (such as BS 102 of FIG. 2) receives, from a UE (such as UE 116 of FIG. 1), an indication that the UE supports synchronized data transmission.

In some embodiments, the BS may transmit, to the UE, a message requesting a capability of the UE to support synchronized data transmission. In these embodiments, the BS may receive the indication that the UE supports synchronized data transmission in response to transmission of the message.

At step 720, the BS transmits, to the UE, a configuration indicating a linking between at least two data flows of a plurality of data flows for synchronized data transmission.

In some embodiments, the configuration indicating the linking between the plurality of data flows for synchronized data transmission is included in an RRC reconfiguration message.

In some embodiments, the BS may receive, from the UE a message including one of a plurality of data flows for which synchronized data transmission is requested, wherein each data flow of the plurality of data flows is one of a DRB or an LCH, and QoS flows of a PDU session for which synchronized data transmission is requested. In these embodiments, the BS may transmit the configuration indicating the linking between the plurality of data flows in response to receiving the message.

At step 730, the BS transmits, to the UE, a configuration of a synchronization threshold for the linked at least two data flows.

Although FIG. 7 illustrates one example method for synchronized data transmission 700, various changes may be made to FIG. 7. For example, while shown as a series of steps, various steps in FIG. 7 could overlap, occur in parallel, occur in a different order, occur any number of times, be omitted, or replaced by other steps.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A user equipment (UE) comprising:
a processor; and
a transceiver operatively coupled to the processor, the transceiver configured to:
transmit, to a base station (BS), an indication that the UE supports synchronized data transmission;
receive, from the BS, a configuration indicating a linking between at least two data flows of a plurality of data flows for synchronized data transmission, wherein each data flow of the plurality of data flows is one of a data radio bearer (DRB) or a logical channel (LCH); and
receive, from the BS, a configuration of a synchronization threshold for the linked at least two data flows.

2. The UE of claim 1, wherein the transceiver is further configured to:
receive, from the BS, a message requesting a capability of the UE to support synchronized data transmission; and
transmit the indication that the UE supports synchronized data transmission in response to receiving the message.

3. The UE of claim 1, wherein the transceiver is further configured to:
transmit, to the BS, a message including one of:
a plurality of data flows for which synchronized data transmission is requested, wherein each data flow of the plurality of data flows is one of a DRB or an LCH; and
quality of service (QOS) flows of a protocol data unit (PDU) session for which synchronized data transmission is requested; and
receive the configuration indicating the linking between the plurality of data flows in response to transmission of the message.

4. The UE of claim 1, wherein the processor is configured to, upon transmission by the transceiver of a data packet in a first data flow of the linked at least two data flows, set a packet data convergence protocol (PDCP) discard timer of an associated data packet of a second data flow of the linked at least two data flows to a minimum of a current value of a discard timer and the synchronization threshold.

5. The UE of claim 1, wherein the processor is configured to:
upon transmission by the transceiver of a data packet in a first data flow of the linked at least two data flows, determine whether an associated data packet of a second data flow of the linked at least two data flows is transmitted within the synchronization threshold; and
in response to a determination that the associated data packet is not transmitted within the synchronization threshold, discard the associated data packet.

6. The UE of claim 1, wherein the processor is configured to:
determine whether a data packet associated with a data packet transmitted in a first data flow of the linked at least two data flows is buffered or available for transmission in a second data flow of the linked at least two data flows; and
in response to a determination that the data packet associated with the data packet transmitted in the first data flow is buffered or available for transmission in the second data flow, apply a priority of the first data flow to the second data flow.

7. The UE of claim 1, wherein the processor is configured to:
determine whether a data packet associated with a data packet transmitted in a first data flow of the linked at least two data flows is buffered or available for transmission in another data flow of the linked at least two data flows; and
in response to a determination that the data packet associated with the data packet transmitted in the first data flow is buffered or available for transmission in the other data flow of the linked at least two data flows, prioritize multiplexing the data packet from the other data flow of the linked at least two data flows before multiplexing data packets from data flows not linked to the first data flow.

8. The UE of claim 1, wherein the configuration indicating the linking between the plurality of data flows for synchronized data transmission is included in a radio resource control (RRC) reconfiguration message.

9. A base station (BS) comprising:
a processor; and
a transceiver operatively coupled to the processor, the transceiver configured to:
receive, from a user equipment (UE), an indication that the UE supports synchronized data transmission;
transmit, to the UE, a configuration indicating a linking between at least two data flows of a plurality of data flows for synchronized data transmission, wherein each data flow of the plurality of data flows is one of a data radio bearer (DRB) or a logical channel (LCH); and
transmit, to the UE, a configuration of a synchronization threshold for the linked at least two data flows.

10. The BS of claim 9, wherein the transceiver is further configured to:
transmit, to the UE, a message requesting a capability of the UE to support synchronized data transmission; and
receive the indication that the UE supports synchronized data transmission in response to transmission of the message.

11. The BS of claim 9, wherein the transceiver is further configured to:
receive, from the UE, a message including one of:
a plurality of data flows for which synchronized data transmission is requested, wherein each data flow of the plurality of data flows is one of a DRB or an LCH; and
quality of service (QOS) flows of a protocol data unit (PDU) session for which synchronized data transmission is requested; and
transmit the configuration indicating the linking between the plurality of data flows in response to receiving the message.

12. The BS of claim 9, wherein the configuration indicating the linking between the plurality of data flows for synchronized data transmission is included in a radio resource control (RRC) reconfiguration message.

13. A method of operating a user equipment (UE), the method comprising:
transmitting, to a base station (BS), an indication that the UE supports synchronized data transmission;
receiving, from the BS, a configuration indicating a linking between at least two data flows of a plurality of data flows for synchronized data transmission, wherein each data flow of the plurality of data flows is one of a data radio bearer (DRB) or a logical channel (LCH); and
receiving, from the BS, a configuration of a synchronization threshold for the linked at least two data flows.

14. The method of claim 13, further comprising receiving, from the BS, a message requesting a capability of the UE to support synchronized data transmission,
wherein the indication that the UE supports synchronized data transmission is transmitted in response to receiving the message.

15. The method of claim 13, further comprising:
transmitting, to the BS, a message including one of:
a plurality of data flows for which synchronized data transmission is requested, wherein each data flow of the plurality of data flows is one of a DRB or an LCH; and
quality of service (QOS) flows of a protocol data unit (PDU) session for which synchronized data transmission is requested; and
receiving the configuration indicating the linking between the plurality of data flows in response to transmission of the message.

16. The method of claim 13, further comprising, upon transmission of a data packet in a first data flow of the linked at least two data flows, setting a packet data convergence protocol (PDCP) discard timer of an associated data packet of a second data flow of the linked at least two data flows to a minimum of a current value of a discard timer and the synchronization threshold.

17. The method of claim 13, further comprising:
upon transmission of a data packet in a first data flow of the linked at least two data flows, determining whether an associated data packet of a second data flow of the linked at least two data flows is transmitted within the synchronization threshold; and
in response to a determination that the associated data packet is not transmitted within the synchronization threshold, discarding the associated data packet.

18. The method of claim 13, further comprising:
determining whether a data packet associated with a data packet transmitted in a first data flow of the linked at least two data flows is buffered or available for transmission in a second data flow of the linked at least two data flows; and
in response to a determination that the data packet associated with the data packet transmitted in the first data flow is buffered or available for transmission in the second data flow, applying a priority of the first data flow to the second data flow.

19. The method of claim 13, further comprising:
determining whether a data packet associated with a data packet transmitted in a first data flow of the linked at least two data flows is buffered or available for transmission in another data flow of the linked at least two data flows; and
in response to a determination that the data packet associated with the data packet transmitted in the first data flow is buffered or available for transmission in the other data flow of the linked at least two data flows, prioritizing multiplexing the data packet from the other data flow of the linked at least two data flows before multiplexing data packets from data flows not linked to the first data flow.

20. The method of claim 13, wherein the configuration indicating the linking between the plurality of data flows for synchronized data transmission is included in a radio resource control (RRC) reconfiguration message.
